(19) United States
(12) Patent Application Publication
(10) Pub. No.: US 2009/0256053 A1
(43) Pub. Date: Oct. 15, 2009

(54) Stop element for a concrete formwork

(75) Inventors: Thomas Foser, Balzers (LI); Ferenc Lor, Buchs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/384,807

(22) Filed: Apr. 8, 2009

(30) Foreign Application Priority Data
Apr. 14, 2008 (DE) 10 2008 001 170.3

(51) Int. Cl. B29C 39/32

(52) U.S. Cl. 249/1

(57) ABSTRACT

A stop element for a concrete formwork, includes a base member (11) having a base (12) for mounting the stop element on a constructional component and having a through-opening (13) provided with an abutment (14) for a fastening element, and at least one stop surface (16) for a formwork wall (30). The stop element further includes and at least one support member (20) extending in a direction away from the at least one support surface (16) and having at least one foot (23) spaced from the through-opening (13), in a direction perpendicular to the at least one stop surface (16), by a distance (G) greater than (the distance (F)) the at least one stop surface (16) is spaced from the through-opening (13).

### BACKGROUND OF THE INVENTION

1. Field of the Invention

The present invention relates to a stop element for a concrete formwork including a base member having a base for mounting the stop element on a constructional component and having a through-opening provided with an abutment for a fastening element, and at least one stop surface for a formwork wall.

2. Description of the Prior Art

European Patent Publication EP 0 971 084 A1 discloses a stop element having a base member with a cylindrical outer wall and having a base for mounting the stop element on a constructional component. In the outer wall, above a false floor, there are provided openings over which a wire mesh can be secured with wires. As a support surface for the wire mesh, an end surface of the outer wall, at the remote end of which the base is located, serves. The outer wall further forms a stop surface for the framework. In the center of the false floor, a sleeve is arranged. The sleeve forms a through-opening for the fastening element and defines an attachment axis of the stop element.

The drawback of the known stop element consists in that upon impact of the formwork wall on the formwork stop during mounting of the formwork, the stop element easily tilts at its base, whereby the support characteristics of the stop element become worse.

An object of the present invention, is to provide a stop element having improved support characteristics for supporting formwork walls.

### SUMMARY OF THE INVENTION

This and other objects of the present invention, which will become apparent hereinafter, are achieved by providing a stop element having at least one support member extending in a direction away from the at least one support surface and having at least one foot for being placed on the constructional component and spaced from the through-opening in the base in a direction perpendicular to the at least one stop surface, by a distance greater than the distance the at least one stop surface is spaced from the through-opening in the direction perpendicular to the stop surface. The support member noticeably improves the resistance of the stop element against tilting and improves the support characteristics of the stop element.

Advantageously, the stop element includes at least two support members arranged mirror-symmetrically with respect to a plane defined by the at least one stop surface and the through-opening in the base. The provision of two support members improves the support characteristics of the inventive stop element even more.

It is further advantageous when the support members each has a flat triangular shape. This ensures saving of the material without any loss of stability. The support members are formed, e.g., as wall sections.

It is also advantageous when the base member has a circumferential wall having a circular cross-section from which the support members project in tangential direction. Thereby, the stop element widens in a directing perpendicular to the stop surface for the formwork wall. The stop element with the circumferential wall has essentially a triangular cross-section that insures the stability of the stop element.

Advantageously, the attachment surfaces of the base and the at least one foot lie in a common plane, which enables placement of the stop element on a flat plane of a constructional component wobbling-free.

The stability of the stop element in a direction transverse to the plane defined by the stop surface and the through-opening in the base of the base member is increased when the two support members are connected with each other by a cross member.

Advantageously, the stop element has, at least one truss for supporting a reinforcing rod and which projects from the circumferential wall of the stop element. The truss provides for mounting and support of the reinforcing rod.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of a stop element according to a first embodiment of the present invention;

FIG. 2 a cross-sectional view of the stop element shown in FIG. 1 along line 11-11 with an added reinforcing rod; and

FIG. 3 a perspective view of a stop element according to a second embodiment of the present invention with a reinforcing rod.

### DETAILED DESCRIPTION OF THE PREFERRED EMBODIMENTS

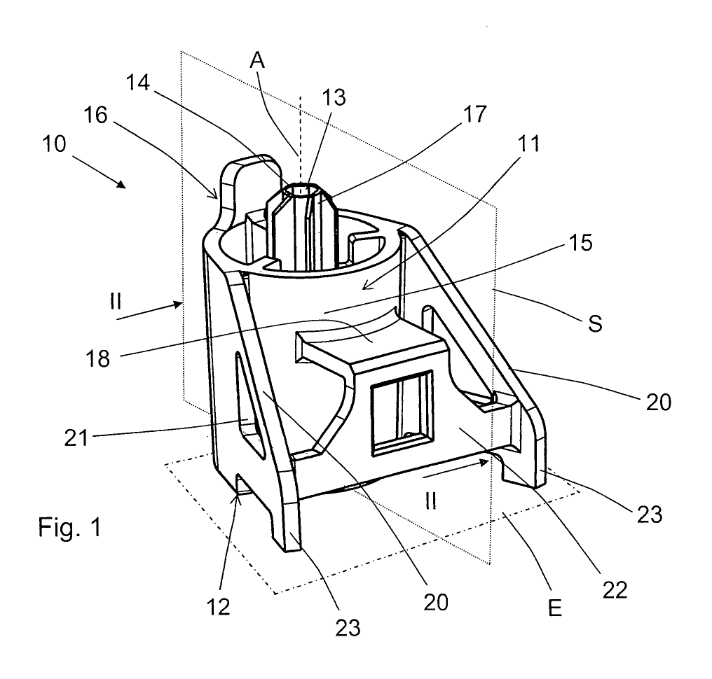

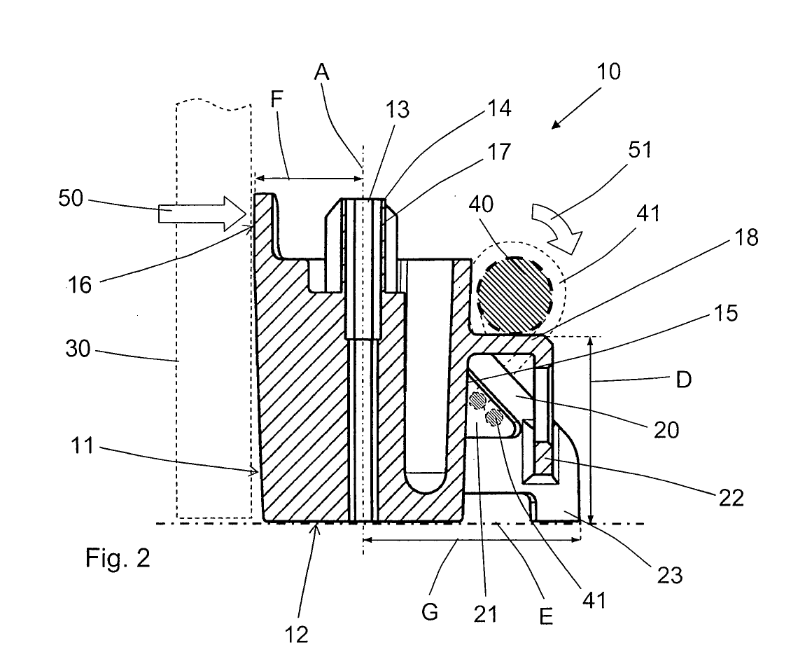

A stop element 10, which is shown in FIGS. 1-2 and is formed, e.g., as formwork stop, includes a base member 11 having preferably circular cross-section and a base 12 for mounting the stop element 10 on a constructional component (not shown in the drawings). The base 12 has at least one attachment surface. The base member 11 has a through-opening 13 for a fastening element (not shown in the drawings) and defining an axis A. Around the through-opening 13, there is provided an abutment 14 for the fastening element. The abutment 14 is arranged on a sleeve 17 projecting from the base body 11.

The stop element 10 further includes a circumferential wall 15 and at least one stop surface 16 for a formwork wall 30. The stop surface 16 is at least partially formed by the circumferential wall 15. A truss 18, which projects sidewise from the circumferential wall 15 of the stop element 10 serves as a support surface for a reinforcing rod 40 (see FIG. 2).

The truss 18 or the support surface, which is formed thereby, for the reinforcing rod 40, extends substantially perpendicular to the axis A and is spaced by a distance D from the base E and which corresponds to from 1.5 to 2 times of the distance F of the stop surface 16 from the through-opening 13, but does not exceed an absolute length of 2.5 cm. Two support members 20, which are formed as ramps, project from the base member 11 in a direction away from the attachment surface 16. The support members 20 each has a foot 23 the attachment surface of which, with which the foot 23 is supported on the constructional component, lies in the common plane E with the at least one attachment surface of the base 12 of the base member 11. The support members 20 have a triangular flat shape and each has an opening through which a linking element 41 such as, e.g., wire for a reinforcing rod 40 can pass (see FIG. 2). The support members 20 are arranged on the base member 11 mirror-symmetrically with respect to the plane S defined by the stop surface 16 and the opening 13. A cross-member 22 connects the two support members 20 with each other, reinforcing them relative to each other. Simultaneously, the cross-member 22 supports the truss 18.

As particularly shown in FIG. 2, a load (in a loading direction 50) can be applied to the stop element 10 via the formwork wall 30 that abuts the stop surface 16, which can lead to tilting or inclination of the stop element 10 in direction of arrow 51. The support members 20, the feet of which are spaced in the loading direction 50 (i.e., in the direction transverse to the stop surface 16) further from the through-opening 13 or the axis A (distance G) than the stop surface 16 from the through-opening 13 (relative to the axis of the through-opening) (distance F), provide for a greater resistance to tilting of the stop element 10.

The distance G is measured with respect to the radially outer end of the foot 23.

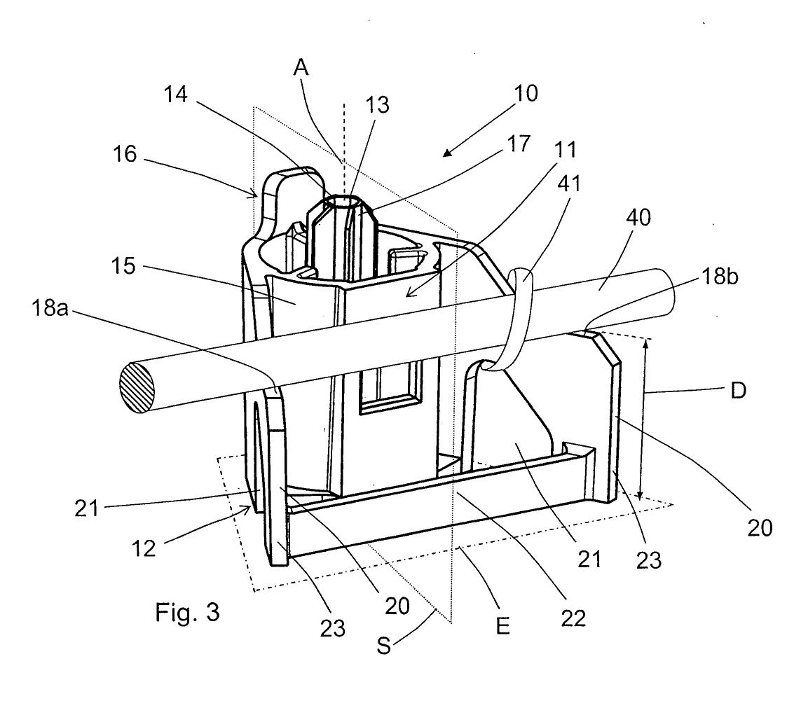

The stop element shown in FIG. 3 differs from the stop element 10 described above in that instead of a single truss 18, two trusses 18a, 18b are formed directly on the two support members 20. Beneath the trusses 18a, 18b, there are provided respective openings 21 in support members 20. A linking element 41, e.g., a wire for the reinforcing rod 40 can pass through a respective opening 21. The trusses 18a, 18b or the support surfaces, which are formed thereby, for the reinforcing rod 40 are spaced from the plane E by a distance D that corresponds to from 1.5 to 2 times of the distance of the stop surface 16 from the opening 13 (see FIG. 2), but the absolute length does not exceed 2.5 cm. With respect to the description of other elements with respective reference numerals, reference should be made to description with reference to FIGS. 1-2.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A stop element for a concrete formwork, comprising a base member (11) extending along an axis (A) and having a base (12) for mounting the stop element on a constructional component and having a through-opening (13) provided with an abutment (14) for a fastening element, and at least one stop surface (16) for a formwork wall (30); and at least one support member (20) extending in a direction away from the at least one support surface (16) and having at least one foot (23) for being placed on the constructional component, the at least one foot (23) being spaced from the through-opening (13), in a direction perpendicular to the at least one stop surface (16), by a distance (G) greater than (the distance (F)) the at least one stop surface (16) is spaced from the through-opening (13) in the direction perpendicular to the at least one stop surface (16).

2. A stop element according to claim 1, comprising at least two support members (20) arranged mirror-symmetrically with respect to a plane defined by the at least one stop surface (16) and the through-opening (13) in the base members (12).

3. A stop element according to claim 1, wherein the at least two support members (20) have each a flat triangular shape.

4. A stop element according to claim 2, wherein the base member (11) has a circumferential wall having a circular cross-section from which the support members (20) project in tangential direction.

5. A stop element according to claim 1, wherein attachment surfaces of the base (12) and the at least one foot (23) lie in a common plane (E).

6. A stop element according to claim 2, comprising a cross-member (22) for connecting the at least two support members (20) with each other.

7. A stop element according to claim 1, comprising a circumferential wall (15), and at least one truss (18, 18a, 18b) for supporting a reinforcing rod (40) and projecting sidewise from the circumferential wall (15).

8. A stop element according to claim 7, wherein the at least one truss (18a) is provided on the at least one support member (20).
